(19) United States
(12) Patent Application Publication
(10) Pub. No.: US 2002/0007677 A1
(43) Pub. Date: Jan. 24, 2002

(54) Printed circuit board inclinometer/accelerometer

(76) Inventors: Joann M. Coates, Mantua, NJ (US); Ned Denigan, West Chester, PA (US)

Correspondence Address: Mark J. Marcelli, Ratner & Prestia, One Westlakes, Berwyn, Suite 301, P.O. Box 980, Valley Forge, PA, 19482-0980, US

(21) Appl. No.: 09/887,380

(22) Filed: Jun. 22, 2001

Related U.S. Application Data
(62) Division of application No. 09/466,749, filed on Dec. 17, 1999.

(51) Int. Cl. G01P 15/00

(52) U.S. Cl. 73/514.16

(57) ABSTRACT

A compact and lightweight condition responsive sensor unit of printed circuit board construction includes a deflectable sensor plate integral within a multi-layered printed circuit board and suspended within a cavity formed between a pair of printed circuit boards. Flexure arms allow for movement of the deflectable sensor plate within the cavity in a direction generally perpendicular to the printed circuit boards. The deflectable sensor plate is formed of a conductive material and moves in response to acceleration, inclination, changes in pressure, and other conditions. The conductive, deflectable sensor plate may form the central plate of a differential capacitor, or other sensing means such as contact plates or proximity sensors may be used.

### FIELD OF THE INVENTION

The field of the present invention is that of condition responsive sensor units such as accelerometers and inclinometers and the like, and the present invention relates more particularly to a deflectable sensor plate included within a multi-layered printed circuit board.

### BACKGROUND OF THE INVENTION

Condition responsive sensors, such as accelerometers, inclinometers and the like, find a wide range of applications in industry, and are commonly used in aircraft, automobile, and boating applications, for example, where sensors are likely to be subjected to shock, vibration, contamination and severe temperature and environmental changes. There are many examples of seismic mass sensors which function as deflectable sensors, for example, the center plate of a balanced loop differential capacitor.

With advancing technology, improved condition responsive sensors are desirable. Lighter, more compact sensors which can be manufactured easily with minimal cost, are especially desirable. It has become increasingly important to manufacture sensors which are of solid construction, and therefore resistant to contamination and other environmental effects, temperature effects, electromagnetic interference, and the effects of vibration and shock. As such, sensors formed on or within brittle substrates such as semiconductor materials, are less desirable and of limited utility. Sensors which are separately micro-machined must later be attached to a sturdy substrate such as a printed circuit board. Sensors which are not solidly encased are subject to contamination and other environmental effects.

As the drive to produce more lightweight and compact sensors continues, it becomes increasingly difficult to fabricate sensors having very small microelectromechanical parts. It has therefore become a challenge in today's field of electronics, and condition responsive sensors more particularly, to produce a versatile condition responsive sensor which is lightweight, compact, inexpensive to manufacture, and which finds a wide range of applications due to the solid construction of a deflectable sensor member which provides a sturdy unit which is resistant to shock, vibration, contamination, electromagnetic interference, and severe temperature and environmental effects.

### SUMMARY OF THE INVENTION

It is an object of the present invention to provide a condition responsive sensor which is versatile in nature and can be adapted for use as an accelerometer, inclinometer, tilt switch, G-switch, pressure switch, or pressure transducer, for example. Briefly described, the novel and improved condition responsive sensor unit of the present invention comprises a condition responsive sensor unit of printed circuit board (PCB) construction. The condition responsive sensor unit includes a deflectable sensor plate functioning as a seismic mass and formed between electrically insulating substrates which are coupled substantially in parallel to form a multi-layered printed circuit board. The electrically insulating substrates may be printed circuit boards or they may be formed of ceramic or other materials commonly used in the PCB industry. The deflectable sensor plate which is disposed and encapsulated between the coupled substrates and within the PCB, is suspended and movable within a cavity formed between the substrates, by means of at least one flexure arm which connects the deflectable sensor to a peripheral frame. The deflectable sensor is formed of a conductive material.

The condition responsive sensor unit is of durable construction as the deflectable sensor plate is shielded from environmental effects, and resistant to contamination, shock, vibration, and other mechanical disturbances. The sensing means for sensing movement of the deflectable plate may include a differential, parallel-plate capacitor, it may utilize contact plates, or it may comprise a proximity sensor using optical means or means for sensing the change in a magnetic or other electrical field.

### BRIEF DESCRIPTION OF THE DRAWING

The subject matter which is regarded as the invention is particularly pointed out and distinctly claimed in the concluding portion of the specification. The invention, however, both as to organization and method of practice, together with further objects and advantages thereof, may be best understood by reference to the following description taken in connection with the accompanying drawing.

It is to be understood that the features and objects of the various figures of the drawing are not drawn to scale. Rather, many of the features have been reduced or expanded and/or exaggerated to more clearly point out aspects of the invention, according to common practice.

FIG. 1 is a plan view of an exemplary embodiment of the central plate including the deflectable sensor plate, flexure arms, and a peripheral frame;

FIG. 2 is an exploded, perspective view of the various components of a condition responsive sensor unit according to an exemplary embodiment;

FIGS. 3A and 3B are plan views of electrically insulating substrates having electrical circuits formed thereon;

FIG. 4 is a cross-sectional view of an exemplary embodiment of the condition responsive sensor unit;

FIG. 5 is a cross-sectional view of another exemplary embodiment of to the condition responsive sensor unit using optical sensing means;

FIG. 6 is a cross-sectional view of a condition responsive sensor unit adapted for use as a pressure transducer;

FIG. 7 is a plan view of an exemplary embodiment of the central plate used in the pressure transducer shown in FIG. 6;

FIG. 8 is another exemplary embodiment of the condition responsive sensor unit including multi-layered substrates; and

FIG. 9 is a circuit diagram of an exemplary circuit for providing an output signal from an exemplary embodiment of the condition responsive sensor unit.

### DETAILED DESCRIPTION

The novel and improved condition responsive unit of the present invention provides a conductive deflectable sensor plate integral within a multi-layered printed circuit board. The versatile sensor unit of the present invention can be used for sensing various conditions. Various exemplary embodiments of the particular arrangement of the features of the present invention are shown in the following figures.

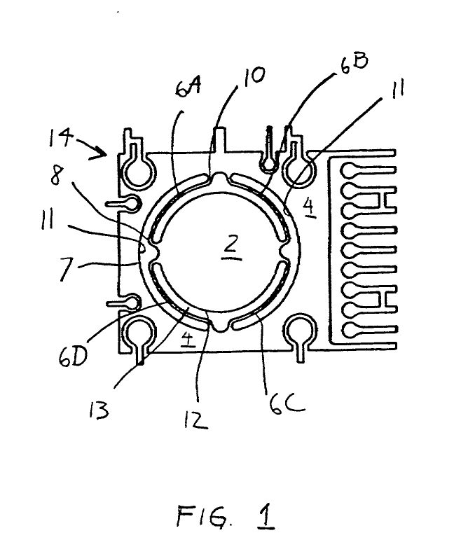

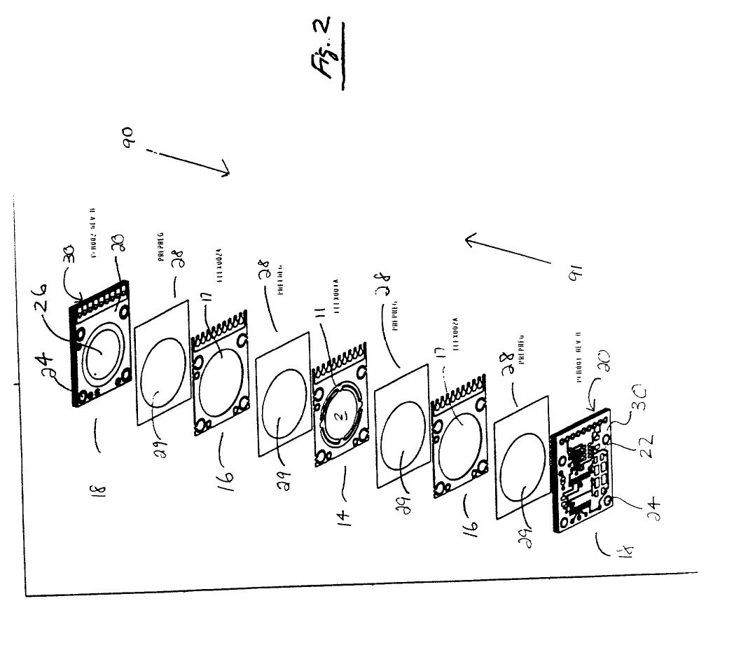

FIG. 1 is a plan view of an exemplary embodiment of the central plate 14 including a deflectable plate 2 or seismic mass of the present invention. A central plate 14 is formed integrally between two substantially parallel electrically insulating substrates (FIG. 2) such as printed circuit boards, which are coupled to each other. Deflectable sensor plate 2 is coupled to peripheral frame 4 by means of a plurality of flexure arms 6A-6D. It can be seen that there is a space 13 between peripheral edge 12 of deflectable sensor plate 2 and inner peripheral edge 7 of peripheral frame 4. Inner peripheral edges 7 define opening 11 within which deflectable plate 2 is disposed. This aspect of the invention, combined with the arrangement of flexure arms 6A-6D provide for a movement of deflectable sensor plate 2 generally perpendicular to the plane of peripheral frame 4 of central plate 14. Flexure arm 6A, for example, is connected to deflectable sensor plate 2 at a first location 8 which is peripherally spaced from a second location 10 wherein flexure arm 6A is coupled to peripheral frame 4 of central plate 14. When formed integrally between generally parallel electrically insulating substrates coupled to each other, deflectable sensor plate 2 is therefore free to move within a cavity formed between the substrates which combine to form a multi-layered printed circuit (PC) board. The construction of the unit, most particularly the arrangement of flexure arms 6A-6D, provides for free movement of deflectable sensor plate 2 with respect to peripheral frame 4 and within the PC board (not shown), in response to conditions such as acceleration, inclination and pressure changes. When in rest position, generally flat deflectable sensor plate 2 is suspended within the plane formed by peripheral frame 4.

Although shown and described in conjunction with four flexure arms each having the same orientation, it should be understood that other exemplary embodiments may include a fewer or greater number of flexure arms than shown in FIG. 1. The flexure arm or arms are designed and arranged so that, in combination, they provide for unencumbered lateral movement of deflectable sensor plate 4 with respect to the plane formed by peripheral frame 4 (and the PC board within which the deflectable sensor plate is included). Deflectable sensor plate 2 of central plate 14 is formed of a conductive material. In an exemplary embodiment, deflectable sensor plate 2 may be formed of beryllium copper. In other exemplary embodiments, other metals such as nickel may be used to form central plate 14, which includes deflectable sensor plate 2.

Now turning to FIG. 2, an exploded perspective view of the various components of an exemplary embodiment of a condition responsive sensor unit, are shown. Central plate 14 is centrally located, and includes deflectable sensor plate 2 disposed within opening 11, shown and described previously in conjunction with FIG. 1. The condition responsive sensor unit of the present invention includes a pair of electrically insulating substrates 18 which are coupled together in assembled form and therefore form the external components of the unit. In the preferred embodiment, each electrically insulating substrate is a printed circuit (PC) board. In an exemplary embodiment, electrically insulating substrates 18 may be formed of a fire retardant epoxy-bonded fiberglass. In another exemplary embodiment, electrically insulating substrates 18 may be formed of other ceramic materials. In yet another exemplary embodiment, electrically insulating substrates 18 may be formed of various other laminated epoxy materials. Although shown as a single electrically insulating substrate, electrically insulating substrate 18 may be a multi-layered substrate structure. According to the preferred embodiment in which electrically insulating substrate 18 is a PC board, each PC board may be a multi-layered PC board. In the embodiments including substrate 18 having multiple layers, electrical circuits and other features may be formed integrally between the layers which combine to form electrically insulating substrate 18, as well as on the outer surface of electrically insulating substrate 18, which forms the outer sections of the condition responsive sensor unit of the present invention.

In various exemplary embodiments, inner surfaces 20 of each electrically insulating substrate 18, may include a conductive plate 26. Conductive plate 26 may be formed of copper or other suitable metals. Outer surfaces 30 of substrates 18 will generally include electrical circuitry 22. The condition responsive sensor unit may also include through-holes 24 extending through electrically insulating substrate 18 to provide electrical connection between the circuitry 22 formed on the surfaces, and the central plate, for example. According to various exemplary embodiments which include each substrate 18 being formed of multiple layers having electrical circuitry on various surfaces, through-holes 24 may provide electrical connection between circuitry formed on various surfaces, and the central plate.

Spacers 16 are disposed between each of substrates 18 and central plate 14. Spacers 16 may be formed of copper or other suitable metals which can be manufactured to tight tolerances. Each spacer 16 includes an opening 17 that extends through spacer 16, which, together with opening 11 in central plate 14, forms a cavity within the assembled condition responsive sensor unit, enabling deflectable sensor plate 2 to move within the cavity and substantially perpendicular to the plane formed by central plate 14. In another exemplary embodiment, more than one spacer 16 may be used between central plate 14 and either or both of substrates 18. Electrically insulating substrates 18, spacers 16, and central plate 14 are laminated together in the arrangement shown by use of “pre-preg” adhesive sheets 28, each of which includes opening 29. By “pre-preg”, it is meant that sheet 28 is formed of a material pre-impregnated with an A-stage epoxy which has been processed and partially cured to form a B-stage epoxy fabric sheet, for example. The semi-cured B-stage epoxy is resistant to reflow during the laminating process used to join the components and further cure adhesive sheets 28. In other exemplary embodiments, other epoxies may be used to form “pre-preg” adhesive sheets 28.

In this manner, the present invention offers the advantage that an adhesive material is not reflowed into a cavity (shown in FIG. 4) formed between substrates 18 during the laminating process which utilizes elevated temperatures. This insures that deflectable sensor plate 2 is free to move within the cavity in response to conditions such as acceleration, inclination and pressure changes. In an exemplary embodiment, the pre-preg material may be a commercially known material grade B11 prepreg “re-flow ” bonding plies.

The components shown and described in conjunction with FIG. 2 are assembled to produce the assembled unit (shown in FIG. 4), using a laminating press. Any suitable laminating press such as available in the art, may be used. The components are positioned as shown for the exemplary embodiment shown in FIG. 2, namely in the following order: first electrically insulating substrate 18, first adhesive sheet 28, first spacer 16, second adhesive sheet 28, central plate 14, third adhesive sheet 28, second spacer 16, fourth adhesive sheet 28, and second electrically insulating substrate 18 (going from top-to-bottom or bottom-to-top). The components are aligned so that respective openings are aligned with one another and with conductive plates 26 of electrically insulating substrates 18. It can be seen that the respective openings formed within the spacers 16, the adhesive sheets 28, and the central plate 14, are essentially the same size and shape according to the exemplary embodiment.

After the components have been positioned and aligned as such, they are laminated together by the laminating press which uses a force directed along opposed directors 90 and 91 and heats the unit being joined at an elevated temperature, typically within the range of 300-400° F. The force directed along opposed directors 90 and 91 and used to join the components together may be on the order of 75-150 psi, but other temperatures and force values may be used alternatively. According to an exemplary embodiment the components may be joined together using a vacuum lamination process as commonly available in the art. Using the preferred laminating temperature of 350° F., the B-stage epoxy used to form adhesive sheet 28 does not reflow during the curing process, offering the advantages as above.

According to another exemplary embodiment (not shown), the spacers may not be needed and each inner surface of the electrically insulating substrates may include a recessed portion formed within the surface. In an exemplary embodiment, the conductive plates (feature 26 shown in FIG. 2) may be included within the recessed portions formed within the inner surfaces of the electrically insulating substrates. During the lamination process as described above, these respective recessed portions are aligned with the openings formed in the adhesive sheets and the central plate, and the components laminated together according to the various exemplary laminating processes described above. The joined components include a central cavity formed of the respective recessed portions formed on the confronting inner surfaces and the central opening of the central plate. The deflectable sensor plate of the central plate is suspended and free to move within the formed cavity.

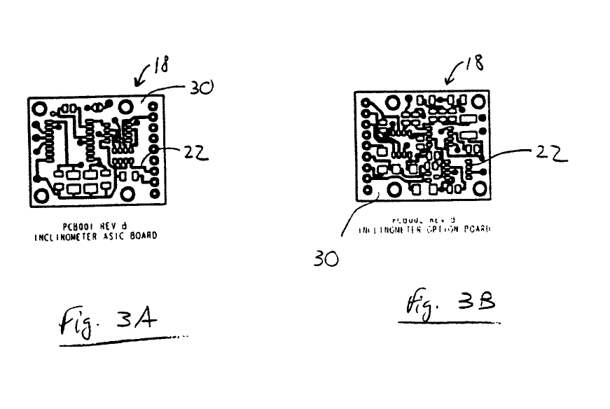

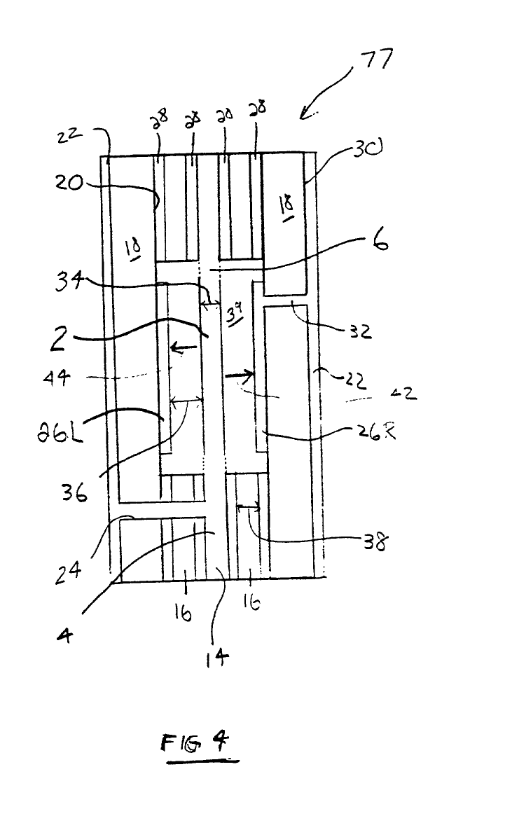

Now turning to FIGS. 3A and 3B, plan views of outer surfaces 30 of electrically insulating substrates 18 are shown. Outer surfaces 30 form the outer surface of the assembled condition responsive sensor unit. FIGS. 3A and 3B show exemplary embodiments of electrical circuit 22 which is formed on surface 30. Electrical circuit 22 may be used to sense and analyze the movement of deflectable sensor plate 2 (not shown) within the condition responsive sensor unit. In the preferred embodiment, each of the electrically insulating substrates 18 shown in FIGS. 3A and 3B may be multi-layered PCB's.

Now turning to FIG. 4, a cross-sectional view of the assembled condition responsive sensor unit is shown. Condition responsive sensor unit (hereinafter, “sensor unit”) 77 is of PC board construction, and represents a multi-layer PC board. Sensor unit 77 includes a pair of electrically insulating substrates 18 which form the outer components of the unit. Although shown and described as a pair of individual substrates, electrically insulating substrate 18 may represent a plurality of individual electrically insulating layers, joined together to form an integral unit as described in conjunction with FIG. 2. Electrically insulating substrates 18 each include an inner surface 20 and an outer surface 30. Disposed on outer surface 30 is electrical circuit 22. Although electrical circuit 22 is shown as being formed on each of the outer surfaces 30, it should be understood that, in other embodiments, electrical circuit 22 may be disposed upon only one of outer surfaces 30.

Sensor unit 77 includes central plate 14 centrally arranged within the unit. Spacers 16 are included between central plate 14 and the pair of electrically insulating substrates 18. Pre-preg adhesive sheets 28 provide for the unit to be laminated together. Cavity 39 is formed integrally within sensor unit 77 because of the centrally located openings included within spacers 16, pre-preg adhesive sheets 28 and central plate 14. (Opening 17 of spacer 16 and opening 29 of sheet 28 are shown in FIG. 2. Opening 11 of central plate 14 is shown in FIG. 1.) Deflectable sensor plate 2 is thereby suspended centrally within cavity 39 when in a rest position, but is free to move along direction 44 or 42 when sensor unit 77 is exposed to acceleration, inclination, or the like. Flexure arms 6 couple deflectable sensor plate 2 to peripheral frame 4 of deflectable sensor plate 14 and thereby centrally suspend deflectable sensor plate 2 within cavity 39. In an exemplary embodiment, thickness 34 of conductive sensing plate 2 may be on the order of 0.004 inches, but may vary in other embodiments. Also in the exemplary embodiment, spacing 36 between deflectable sensor plate 2 and conductive plates 26L, 26R formed on the inner surfaces 20 of the electrically insulating substrates 18, may be on the order of 0.005 to 0.015 inches, but may vary in other exemplary embodiments.

In an exemplary embodiment, each of the pair of inner surfaces 20 includes conductive plates 26L and 26R. When sensor unit 77 is subject to conditions such as acceleration, or inclination, deflectable sensor plate 2 may move along the direction 44 towards conductive plate 26L, or it may move along direction 42 towards conductive plate 26R. In another exemplary embodiment, only one of conductive plate 26L and 26R may be needed. Flexure arm 6 allows for central mass (deflectable sensor plate 2) to move freely and along the indicated directions and substantially perpendicularly with respect to inner surfaces 20.

Various means may be used to form the sensing mechanism. In one exemplary embodiment, conductive plate 26L, conductive deflectable sensor plate 2, and conductive plate 26R may form the parallel plates of a differential capacitor having conductive deflectable sensor plate 2 as a central electrode. Electrical connection is provided between the conductive plates of the parallel plate capacitor through holes 24 and 32 formed through electrically insulating substrates 18 thereby connecting the features to electrical circuits 22 disposed on outer surfaces 30 of electrically insulating substrates 18. Although only two through-holes 24 and 32 are shown, it is understood that any number of holes may be provided to allow for electrically coupling the components of the capacitor to electrical circuitry used in sensing changes in capacitance. Electrical circuits 22 are used as part of the capacitance sensing circuitry in an exemplary embodiment. It should be understood, however, that other external electrical circuitry (not shown) may additionally or alternatively be used. In another exemplary embodiment, wherein substrate 18 is formed of a plurality of insulating layers coupled together, electrical sensing circuitry may be provided along the surface of the multiple layers (not shown) and the components of the capacitor may be coupled to the circuitry through various through-holes. For example, in the preferred embodiment in which substrate 18 is a multi-layered printed circuit board, electrical circuitry may be provided on one or more surfaces of the printed circuit boards which combine to form the multi-layered printed circuit board. Each of the above-described embodiments may be used as an accelerometer, inclinometer, tilt switch, or G-switch.

In another exemplary embodiment, sensor unit 77 may be designed so that the flexure arms allows for deflectable sensor plate 2 to move greater than or equal to distance 36 in either direction 44 or 42. In this embodiment. the range of motion of deflectable sensor plate 2 allows sensor plate 2 to contact either or both of conductive plates 26L and 26R. In this embodiment, conductive plates 26L and 26R serve as contact plates, and the electrical sensing circuitry coupled to the various components forming the contact sensor, are designed to sense contact between conductive, deflectable sensor plate 2 and either or both of conductive plates 26L and 26R.

In another exemplary embodiment, the condition responsive sensor unit 77 of the present invention may use a proximity sensor based on Hall effect, or optical sensing. Still referring to FIG. 4, acceleration or inclination of sensor unit 77 urges motion of deflectable sensor plate 2 along either or both of directions 44 and 42. In this embodiment, however, the motion of deflectable sensor plate 2 is restricted so that it cannot contact either of conductive plates 26L and 26R. Electrical sensing means may be used to detect the proximity of deflectable sensor plate 2 to either of conductive plates 26L and 26R. In another exemplary embodiment (not shown) using a proximity sensor, conductive plates 26L and 26R may not be needed on respective inner surfaces 20.

In one exemplary embodiment of a proximity sensor, magnetic field producing means may be used to produce a magnetic field between deflectable sensor plate 2 and conductive plates 26L and 26R. When deflectable sensor plate 2 moves in response to acceleration or inclination or the like, and its position within cavity 39 changes, electrical circuitry is provided for sensing the change in the magnetic field caused by the movement of deflectable sensor plate 2. In one exemplary embodiment, a Hall effect sensor may be included in the electrical circuit used to sense the change in magnetic field.

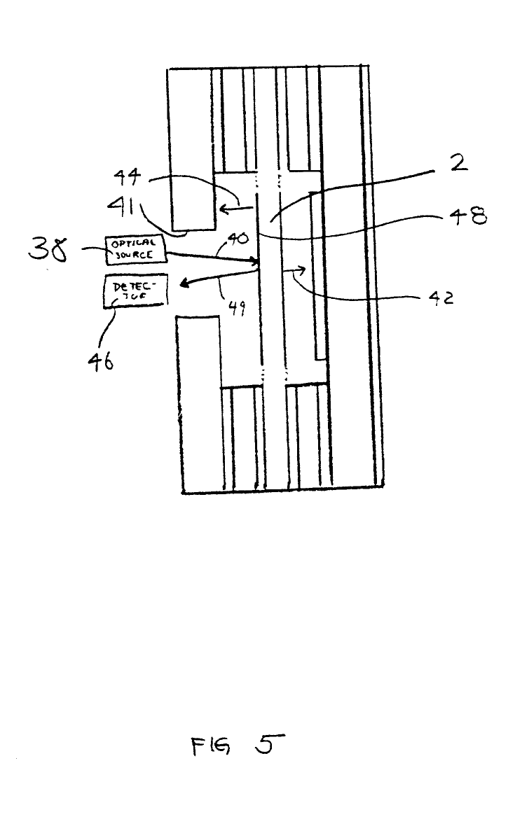

In another exemplary embodiment of a proximity sensor as shown in FIG. 5, reflective optical sensing means may be used. In FIG. 5, optical source 38 provides optical beam 40 through opening 41 and which is directed onto surface 48 of deflectable sensor plate 2. In an exemplary embodiment, optical source 38 may be a photodiode. As the location of deflectable sensor plate 2 within cavity 39 changes responsive to external conditions, and deflectable sensor plate 2 travels along direction 42 or 44, the change in location alters the reflected optical beam 49 and is sensed by optical sensor 46. Optical sensor 46 is coupled to electrical circuitry (not shown) capable of analyzing the changed position. In an exemplary embodiment, optical sensor 46 may be a phototransistor.

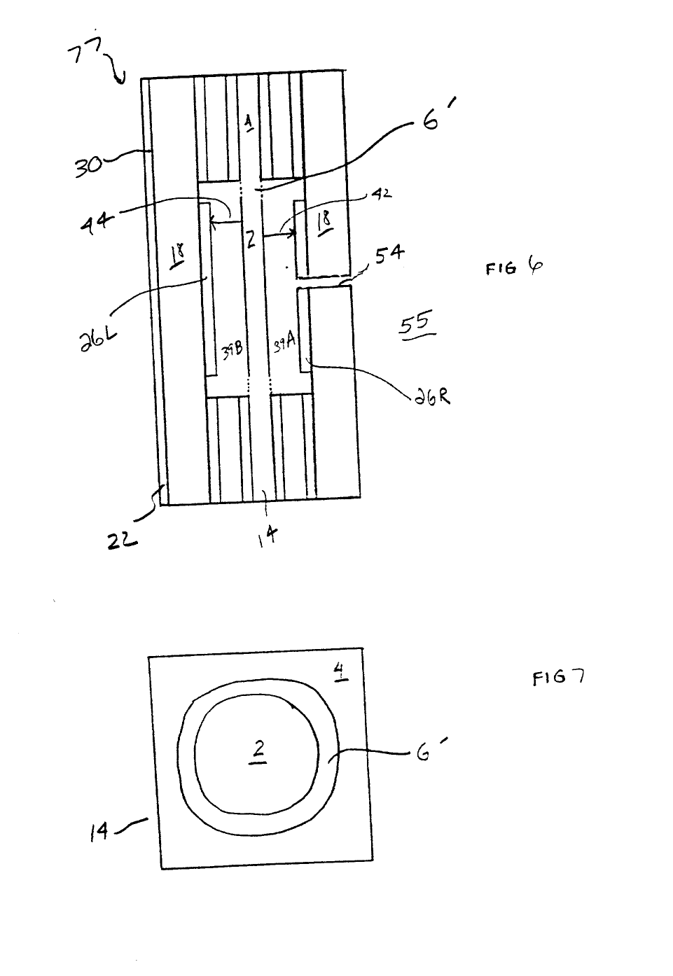

In another exemplary embodiment as shown in FIG. 6, sensor unit 77 of the present invention may form a pressure transducer. In this exemplary embodiment, vent hole 54 allows for vented cavity 39A to be exposed to, and have the same pressure as, external environment 55. Internal cavity 39B is a sealed cavity and therefore maintained at a constant pressure. Changes in the pressure level of external environment 55, and therefore vented cavity 39A, provide for the movement of deflectable sensor plate 2 along direction 44 towards conductive plate 26L, or along direction 42 towards conductive plate 26R. The movement of conductive sensor plate 2 may be sensed using the parallel plate capacitor method, the contact plate method, or the proximity sensing means previously described.

In the exemplary embodiment including a pressure transducer, vented cavity 39A is isolated from internal cavity 39B by means of flexure membrane 6′ which connects deflectable sensor plate 2, to peripheral frame 4 of deflectable sensor plate 14. In this exemplary embodiment, flexure member 6′ is a continuous diaphragm member and does not include holes therethrough, as does the flexure arm arrangement shown in FIG. 1. Rather, the material used to form diaphragm member 6′ is chosen to be gas-impermeable, but bendable in response to pressure changes. Flexure member 6′ therefore maintains a pressure differential across cavity 39B and cavity 39A. Movement of conductive sensor plate 2 along the direction 44 or 42 may be sensed using the various means previously described.

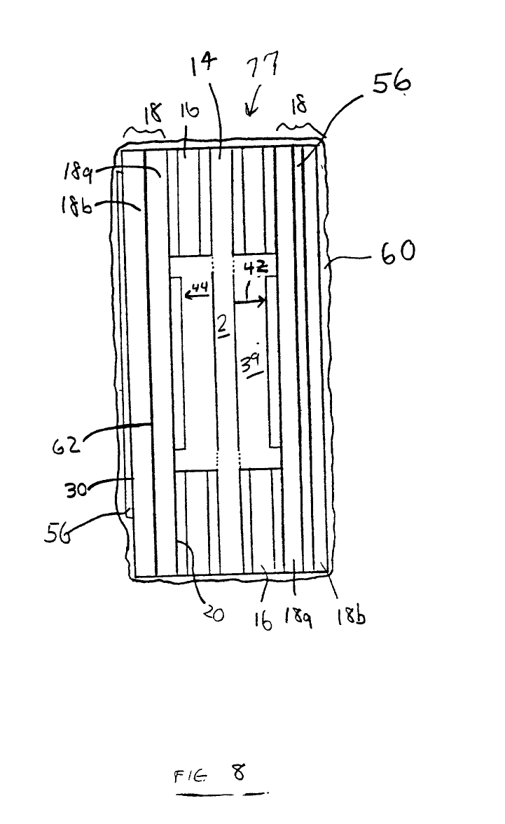

FIG. 7 shows a plan view of the diaphragm unit of the pressure transducer embodiment of the present invention shown in FIG. 6. Flexure member 6′ may be any separating wall or membrane, having an elastic quality, and which is air-tight. In an exemplary embodiment, flexure member 6′ may be a bendable metal, a gas-impermeable fabric, or another elastic, gas-impermeable material.

Returning to FIG. 6, it can be seen that electrical circuit 22 is disposed on only one of the outer surfaces 30 of electrically insulating substrate 18. As described in conjunction with the previous embodiments, it should be understood that the sensor unit 77 forming the pressure sensor embodiment of the present invention, may alternatively include an electrical circuit 22 on each of outer surfaces 30, in order to sense and analyze the movement of deflectable sensor plate 2 as it moves within the cavity formed by cavity sections 39A and 39B.

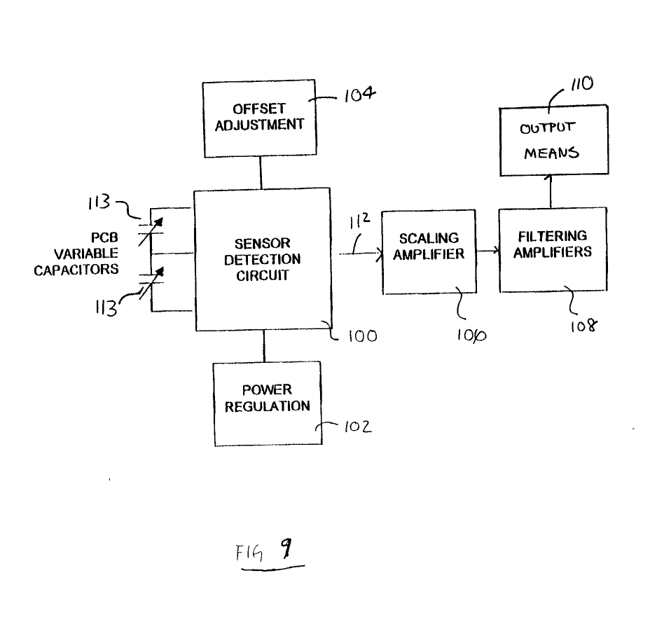

FIG. 8 is an expanded, cross-sectional view of an exemplary embodiment of the condition responsive sensor unit of the present invention including a pair of multi-layered substrates. On each side of the central cavity 39 portion of the sensor unit of the present invention, electrically insulating substrates 18 are shown. Each electrically insulating substrate 18 is formed of two insulating layers. Inner, electrically insulating layer 18a and outer electrically insulating layer 18b combine to form multi-layered electrically insulating substrate 18. Although two layers combine to form multi-layered substrate 18 shown on each side of the embodiment shown in FIG. 8, it should be understood that the multi-layered substrate may contain three or more individual electrically insulating layers coupled together.

In the preferred embodiment, each electrically insulating substrate 18 will be a multi-layered printed circuit board including a number of layers of individual printed circuit boards such as the two (18a, 18b) shown in FIG. 8. Electrical circuit 56 is shown formed between the two layers 18a and 18b on the right side, and along outer surface 30 on the left side, of the exemplary embodiment shown. It should be understood that each individual layer may contain circuitry on either or both surfaces. As such, it should be further understood that each of the various exemplary embodiments of the present invention may include a pair of multi-layered substrates containing two or more individual electrically insulating layers, and each layer may include electrical circuitry on the surface used to sense and analyze the position and the movement of the deflectable sensor plate as it moves within the cavity formed between the substrates.

In the preferred embodiment, the pair of multi-layered printed circuit boards 18, the central plate 14, and the spacers 16 combine to form an integral multi-layer printed circuit board. In the preferred embodiment, the multi-layered printed circuit board includes an internal cavity 39, within which the deflectable sensor plate 2 is suspended and free to move within, generally along directions 42 and 44. It should be further understood that holes (not shown in FIG. 8) may be provided through the substrates as necessary to provide electrically connection between the circuitry disposed on the surfaces of the substrate and the components of the internal parts of the sensing unit.

To protect the assembled, completed sensor unit 77 from the environment the unit may be potted after it is assembled. An epoxy, or other encapsulating material 60 may be formed to cover the outer surfaces of the condition responsive sensor unit.

Now turning to FIG. 9, a circuit diagram showing the circuitry for sensing and analyzing the movement of the deflectable sensor plate of the present invention, is presented. Sensor detection circuit 100 is responsive to the deflectable sensor plate which moves within the cavity in response to acceleration, inclination, pressure changes and the like. Sensor detection circuit 110 senses the magnitude of the movement of the deflectable sensor plate and converts this information into a representative measure of the condition such as acceleration, angle or degree of inclination, and external pressure, to which the unit is being subjected. In the exemplary embodiment shown in FIG. 9, a differential capacitor is used as the sensor unit. In other exemplary embodiments, various other sensing means may be formed using the deflectable sensor plate, such as the contact sensor arrangement and the proximity sensor previously described.

The differential capacitor includes a pair of parallel plate variable capacitors represented as features 113 in the circuit diagram. In an exemplary embodiment using the differential capacitor as a sensor unit, sensor detection circuit 100 may comprise a capacitance sensor detection circuit. Power is provided to sensor detection circuit 100, and regulated by means of power regulation unit 102. Offset adjustment 104 is provided to adjust the offset of signals processed in the sensor detection circuit 100. Output signal 112 of sensor detection circuit 100 is processed by scaling amplifier 106 and filtering amplifiers 108 and is provided to output means 110. Output means 110 may include any of various conventional means available in the art. For example, output means may include an audible alarm, a visual alarm, a digital readout, or any other electrical or visual means which indicates the acceleration value, angle or degree of inclination, or pressure in the environment, for example.

It should be understood that the foregoing exemplary embodiments are intended to be just that—exemplary. The present invention is not intended to be limited to the embodiments shown. Rather, various combinations of the elements described above may be used. For example, the condition responsive sensor unit may be used to sense acceleration, inclination, pressure changes or other conditions. The sensor unit may include a capacitor, a differential capacitor, a contact sensor, and proximity sensors which may use optical, magnetic, or other means to detect proximity. For each of the embodiments, multi-layered electrically insulating substrates such as PCB's may be used on each side of the deflectable sensor plate, and the cavity in which it is free to move. The electrical circuitry used to sense and analyze the motion of the movable sensing plate, is not intended to be limited to a particular type of electrical circuitry. Electrical circuitry may be included on either or both sides of each of the layers which combine to form the electrically insulating substrates. The electrical circuitry is responsive to the particular sensing means used, and combines with other electrical circuitry features to provide an output means indicative of the external condition, as shown in FIG. 9.

The structure of the condition responsive sensor unit is also not intended to be limited to the specific examples shown. For example, each of the various sensors may include a fewer or greater number of flexure arms than the four flexure arms (6A-6D) shown in FIG. 1. The exact configuration and relative placement of the flexure arms may also be varied within the scope of the present invention. Any combination, configuration, and arrangement of flexure arms which provides for free movement of the deflectable sensor plate within the cavity, may be used. The range of motion of the sensor plate is to be determined by the specific application and dimensions used. Spacers of various thicknesses may be used to provide a cavity having the desired dimensions. In alternative embodiments, more than one individual spacer may be used on either or both sides of the centrally disposed deflectable sensor plate. In yet another exemplary embodiment, spacers may not be needed and the inner surfaces of each of the electrically insulating substrates may include recessed portions which are aligned and assembled in confronting relation to form an inner cavity in which the deflectable sensor plate is suspended and is free to move within.

The condition responsive sensor unit of the present invention is a lightweight, compact unit. The materials used in forming the various components of the present invention, are not intended to be limited to the exemplary embodiments described. Any suitable materials having the required functional characteristics, may be used.

The present invention is also not intended to be limited to specific physical dimensions. In the exemplary embodiments shown, the deflectable sensor plate is formed of round construction. In other exemplary embodiments, the deflectable sensor plate may be oblong, elliptical, rectangular, square, or any other suitable shape adapted for of movement within the cavity formed between the pair of substrates. In an exemplary embodiment, the round deflectable sensor plate may have a diameter of 0.5″, but in other exemplary embodiments, sensor plates having diameters ranging from 0.2″ to 3 to 4 inches may be used depending on the specific application. In the exemplary embodiment having a round, 0.5″ deflectable sensor plate, attached to a peripheral frame by a plurality of flexure arms, each spacer may include a central hole having an inner diameter of 0.8″ to accommodate the bending of the flexure arms and the movement of the sensor plate within the cavity. The hole formed in each spacer however, is formed to accommodate the motion of the associated deflectable sensor plate within the cavity. As such, the hole within the spacer may take on various shapes and dimension to accommodate the movement of deflectable sensor plates of different configurations.

In an exemplary embodiment, the thickness of the individual spacers may be 0.010″, but other suitable thicknesses may be used. Also, while the thickness of the central plate including the deflectable sensor plate may be 0.004″ in an exemplary embodiment, other thicknesses ranging from 0.002″ to 0.020″ may be used in other exemplary embodiments, depending on the application and the thickness and number of spacers used which determine the thickness of the cavity within which the deflectable sensor plate is free to move. Also in the exemplary embodiment, the total thickness of the condition responsive sensor unit including the pair of multi-layered electrically insulating substrate, may be within a range of 0.12 to 0.14 inches. It should be understood that other suitable thicknesses may be used in various other exemplary embodiments.

Although several particular exemplary embodiments of the condition responsive sensor unit of the present invention have been described to illustrate the present invention, the present invention includes all modifications and equivalents of the disclosed embodiments falling within the scope of the appended claims.

What is claimed:

1. A condition responsive sensor unit comprising a pair of printed circuit boards coupled together in confronting relationship and therefore forming a multi-layered printed circuit board, each printed circuit board therefore having an inner surface and an outer surface, said inner surfaces being generally parallel to one another, and a generally flat deflectable sensor plate disposed between respective inner surfaces, said deflectable sensor plate formed of a conductive material and adapted for movement between said pair of printed circuit boards along a direction generally perpendicular to said inner surfaces.

2. The condition responsive sensor unit as in claim 1, further comprising said deflectable sensor plate being formed of an integral unit including a peripheral frame and at least one flexure arm coupling said sensor plate to said frame.

3. The condition responsive sensor unit as in claim 1, further comprising a plurality of spacers, at least one spaced between said sensor plate and one of said pair of printed circuit boards and at least one other of said spacers spaced between said sensor plate and said other printed circuit board, each of said plurality of spacers including an opening sized and located to allow for said movement of said sensor plate therethrough, said plurality of spacers creating a cavity between said inner surfaces, and said sensor plate adapted for movement within said cavity.

4. The condition responsive sensor unit as in claim 3, further comprising said deflectable sensor plate being formed of an integral unit including a peripheral frame and at least one flexure arm coupling said sensor plate to said peripheral frame.

5. The condition responsive sensor unit as in claim 4, further comprising a plurality of adhesive layers, at least a first adhesive layer being conterminous with each of one said inner surface and a first spacer, a second adhesive layer being conterminous with each of said other inner surface and a second spacer, a third adhesive layer being conterminous with each of said first spacer and said peripheral frame, and a fourth adhesive layer being conterminous with each of said second spacer and said peripheral frame.

6. The condition responsive sensor unit as in claim 5, wherein each of said plurality of adhesive layers is formed of a no-flow pre-preg material, said pre-preg material formulated to resist flowing during a sealing operation carried out at an elevated temperature.

7. The condition responsive sensor unit as in claim 1, wherein said deflectable sensor plate moves in response to acceleration.

8. The condition responsive sensor unit as in claim 1, wherein said deflectable sensor plate moves in response to inclination.

9. The condition responsive sensor unit as in claim 1, wherein each of said pair of printed circuit boards comprises a multi-layered printed circuit board.

10. The condition responsive sensor unit as in claim 9, wherein at least some of said printed circuit boards of said pair of multi-layered printed circuit boards include an electrical circuit formed on a surface thereof.

11. The condition responsive sensor unit as in claim 1, further comprising an electrical circuit capable of sensing said movement of said deflectable sensor plate.

12. The condition responsive sensor unit as in claim 11, wherein said electrical circuit is disposed on at least one of said outer surfaces.

13. The condition responsive sensor unit as in claim 1, wherein each of said respective inner surfaces includes a conductive plate formed thereon, said conductive plates forming respective outer plates of a differential capacitor, said sensor plate forming a central plate of said differential capacitor, and wherein said movement changes a capacitance of said differential capacitor.

14. The condition responsive sensor unit as in claim 13, further comprising means for measuring said capacitance.

15. The condition responsive sensor unit as in claim 1, wherein each of said respective inner surfaces includes a conductive plate formed thereon, and further comprising means for detecting electrical contact between said sensor plate and at least one conductive plate of said pair of conductive plates.

16. The condition responsive sensor unit as in claim 3, wherein said spacers are each comprised of metal.

17. The condition responsive sensor unit as in claim 1, wherein said sensor plate is formed of beryllium copper.

18. The condition responsive sensor unit as in claim 1, further comprising an electrical circuit formed on at least one surface of at least one printed circuit board of said pair of printed circuit boards.

19. The condition responsive sensor unit as in claim 10, wherein at least one said electrical circuit is coupled to said sensor plate through at least one hole formed through a corresponding multi-layered printed circuit board.

20. The condition responsive sensor unit as in claim 1, wherein said sensor plate forms a central electrode of a differential capacitor.

21. The condition responsive sensor unit as in claim 9, further comprising a ground plane disposed on a surface of a printed circuit board of said pair of multi-layered printed circuit boards, said ground plane capable of electrically grounding said condition responsive sensor unit.

22. The condition responsive sensor unit as in claim 1, wherein said sensor plate has a circular shape.

23. The condition responsive sensor unit as in claim 1, wherein each printed circuit board of said pair of printed circuit boards comprises a fire-retardant epoxy-bonded fiberglass.

24. The condition responsive sensor unit as in claim 1, wherein each printed circuit board of said pair of printed circuit boards is comprised of a ceramic material.

25. The condition responsive sensor unit as in claim 1, wherein each printed circuit board of said pair of printed circuit boards is comprised of a laminated epoxy material.

26. The condition responsive sensor unit as in claim 1, further comprising an epoxy material encapsulating said condition responsive sensor unit.

27. The condition responsive sensor unit as in claim 1, wherein one of said printed circuit boards includes a hole therethrough, said sensor plate is thereby exposed to an outer environment through said hole, said sensor plate moves in response to pressure changes in said outer environment, and said condition responsive sensor therefore functions as a pressure transducer.

28. The condition responsive sensor unit as in claim 1, wherein each of said respective inner surfaces includes a conductive plate formed thereon, said conductive plates aligned with said sensor plate.

29. The condition responsive sensor unit as in claim 11, wherein said electrical circuit capable of sensing said movement of said sensor plate includes a proximity sensor for sensing a proximity of said sensor plate and at least one of said inner surfaces.

30. The condition responsive sensor unit as in claim 29, wherein said proximity sensor senses said proximity using optical means.

31. The condition responsive sensor unit as in claim 29, further comprising means for producing a magnetic field between said sensor plate and a conductive plate formed on at least one of said inner surfaces.

32. The condition responsive sensor unit as in claim 31, wherein said proximity sensor senses a proximity of said sensor plate and said conductive plate by detecting a difference in said magnetic field.

33. The condition responsive sensor unit as in claim 2, wherein each flexure arm is connected to said sensor plate at a first connection point and further coupled to said peripheral frame at a second connection point being peripherally spaced from said first connection point.

34. The condition responsive sensor unit as in claim 33, wherein said flexure arms are four in number.

35. A multi-layered printed circuit board including a condition responsive sensor unit formed therewithin, said condition responsive sensor unit disposed within a cavity formed within said multi-layered printed circuit board, said cavity bounded by a pair of opposed surfaces being generally parallel to one another, said condition responsive sensor unit including a generally flat deflectable sensor plate suspended within said cavity, formed of a conductive material and adapted for movement between said opposed surfaces along a direction generally perpendicular to said opposed surfaces.

36. A condition responsive sensor unit comprising:
a) a pair of multi-layered printed circuit boards coupled together in confronting relationship, each therefore having an inner surface and an outer surface, each of said inner surfaces including a conductive plate formed thereon;
b) a generally flat deflectable sensor plate formed of a conductive material, said sensor plate disposed between said conductive plates of said respective inner surfaces and formed of an integral unit including a peripheral frame and at least one flexure arm coupling said sensor plate to said peripheral frame, each flexure arm connected to said sensor plate at a first connection point and further coupled to said peripheral frame at a second connection point being peripherally spaced from said first connection point;
c) a plurality of generally flat spacers, at least one spaced between said peripheral frame and one of said pair of multi-layered printed circuit boards and at least one other of said spacers spaced between said peripheral frame and said other multi-layered printed circuit board, each of said plurality of spacers including an opening sized and located to allow for movement of said sensor plate therethrough, said plurality of spacers creating a cavity between said inner surfaces, and said sensor plate adapted for movement within said cavity responsive to at least one of acceleration and inclination, in a direction perpendicular to said inner surfaces;
d) a plurality of adhesive layers, at least a first adhesive layer being conterminous with each of one said inner surface and a first spacer, a second adhesive layer being conterminous with each of said other inner surface and a second spacer, a third adhesive layer being conterminous with each of said first spacer and said peripheral frame, and a fourth adhesive layer being conterminous with each of said second spacer and said peripheral frame; and
e) electrical circuitry formed on at least some of said printed circuit boards of said pair of multi-layered printed circuit boards, said electrical circuitry capable of sensing said movement of said sensor plate.

37. A generally flat sensor unit adapted for placement in a multi-layer printed circuit board, said sensor unit defining a plane and comprising a peripheral frame and a deflectable central plate adapted for perpendicular movement with respect to said plane and coupled to said peripheral frame by at least one flexure arm.

38. The generally flat sensor unit as in claim 37, wherein each flexure arm is coupled to said central plate at a first connection point and further coupled to said peripheral frame at a second connection point being peripherally spaced from said first connection point.

39. A method for forming a multi-layered printed circuit board including a condition responsive sensor formed therewithin, comprising the steps of:
a) providing a plurality of components including
i) a pair of printed circuit boards each having a conductive plate formed on a surface thereof,
ii) a generally flat peripheral frame having a first opening therein and a deflectable sensor plate coupled to said frame and disposed within said first opening,
iii) a pair of spacers, each having a pair of opposed faces and including a second opening having essentially the same size and shape as said first opening, and
iv) a plurality of adhesive layers, each including a third opening having essentially the same size and shape as said first opening;
b) positioning said components with said peripheral frame being positioned between said pair of printed circuit boards, a spacer of said pair of spacers being positioned between said peripheral frame and each of said printed circuit boards and an adhesive layer of said plurality of adhesive layers being positioned along each of said opposed faces of each of said pair of spacers;
c) aligning said openings with one another and with said conductive plates; and
d) heating and applying pressure directed to joining said components together using a laminating press, thereby joining said components to form said multi-layered printed circuit board having a cavity therewithin, said sensor plate being suspended within said cavity and capable of movement within said cavity.

40. The method as in claim 39, in which said step d) includes heating at a temperature within a range of 300° F. to 400° F.

41. The method as in claim 39, in which said step d) includes applying a pressure within a range 75 to 150 psi.

42. The method as in claim 39, wherein said step d) comprises joining by vacuum lamination.

43. The method as in claim 39, wherein said step d) comprises laminating said components together.

44. The method as in claim 39, wherein each of said printed circuit boards comprises a multi-layered printed circuit board.

45. The method as in claim 39, wherein each of said plurality of adhesive layers comprises a no-flow pre-preg material, and wherein said adhesive layers do not reflow during said step d).

46. The method as in claim 39, wherein each of said plurality of adhesive layers comprises a B-stage epoxy, and wherein said adhesive layers do not reflow during said step d).

47. A method for forming a multi-layered printed circuit board including a condition responsive sensor formed therewithin, comprising the steps of:
a) providing a plurality of components including
i) a pair of multi-layered printed circuit boards, each including an inner surface having a conductive plate formed in a recessed portion thereof,
ii) a generally flat peripheral frame forming a plane and having a first opening therein and a deflectable sensor plate coupled to said frame, disposed within said first opening, and adapted for generally perpendicular movement with respect to said plane,
iii) a plurality of adhesive layers, each including a second opening having essentially the same size and shape as said first opening;
b) positioning said components with said peripheral frame being positioned between said pair of multi-layered printed circuit boards, and an adhesive layer of said plurality of adhesive layers being positioned between said pair of multi-layered printed circuit boards and said peripheral frame;
c) aligning said openings with one another and with said conductive plates; and
d) heating and applying pressure directed to joining said components together using a laminating press, thereby joining said components to form said multi-layered printed circuit board having a cavity therewithin, said sensor plate being suspended within said cavity and capable of movement within said cavity.

48. The method as in claim 47, wherein each of said plurality of adhesive layers comprises a no-flow pre-preg materials, and wherein said adhesive layers do not reflow during said step d).

49. The method as in claim 47, wherein each of said plurality of adhesive layers comprises a B-stage epoxy, and wherein said adhesive layers do not reflow during said step d).
